(19) United States
(12) Patent Application Publication
(10) Pub. No.: US 2024/0182374 A1
(43) Pub. Date: Jun. 6, 2024

(54) COCRYSTAL FERTILIZERS

(71) Applicant: ICL EUROPE COOPERATIEF U.A., Amsterdam (NL)

(72) Inventor: Khalil ABU-RABEAH, Beer Sheva (IL)

(21) Appl. No.: 18/285,253

(22) PCT Filed: May 18, 2022
(86) PCT No.: PCT/IL2022/050516

§ 371 Date: Oct. 1, 2023

Related U.S. Application Data
(60) Provisional application No. 63/189,768, filed on May 18, 2021.
(60) Provisional application No. 63/271,122, filed on Oct. 23, 2021.

(51) Int. Cl. C05C 3/00; C05B 7/00; C05C 9/00

(52) U.S. Cl. CPC C05C 3/00; C05B 7/00; C05C 9/00

(57) ABSTRACT

According to some embodiments, there is provided herein a cocrystal of Polyhalite and an N-fertilizer.

### FIELD OF THE INVENTION

The present invention relates to the field of fertilizers, specifically to the production a cocrystal fertilizer containing Polyhalite and nitrogen.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:
Nitrogen (N): leaf growth;
Phosphorus (P): Development of roots, flowers, seeds, fruit;
Potassium (K): Strong stem growth, movement of water in plants, promotion of flowering and fruiting;
three secondary macronutrients: calcium (Ca), magnesium (Mg), and Sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts.

The most reliable and effective way to make the availability of nutrients coincide with plant requirements is by controlling their release into the soil solution, using slow release or controlled release fertilizers.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development.

Polyhalite is an evaporite mineral, a hydrated sulfate of potassium, calcium and magnesium with formula: K2Ca2Mg(SO4)4·2H2O. Polyhalite is used as a fertilizer since it contains four important nutrients and is low in chloride:
48% SO3 as sulfate
14% K2O
6% MgO
17% CaO

Nitrogen is the essential soil mineral nutrient needed in the greatest quantity by plants and is a primary component of biological cycles. N fertilizer may contain Urea, Nitrate salts, Ammonium salts like ammonium nitrate, calcium ammonium nitrate, magnesium ammonium nitrate, ammonium sulphate, ammonium phosphate

Urea, CO(NH₂)₂, has been the most prominent nitrogen Fertilizer, wherein about 65% of global nitrogen use is in the fertilizer industry.

The process of producing urea is a double edged sword, whereas on the one hand the production of ammonia consumes vast amounts of energy, yet on the other hand about 50% or less of the N-fertilizer is properly absorbed by the plants, making it a very efficient fertilizer.

Urea may be synthesized from ammonia and carbon dioxide, and may have the following process:

3CO(NH₂)₂+3H₂O=2NH₄+HCO₃+OH

This reaction is catalyzed by the Urease enzyme.

The high pH causes an intensive emission of ammonia and the ammonium ion may undergo anaerobic reactions from NO₃ to NO, N₂O, N₂.

In the reaction there are N-value losses all, and in addition, the gases NO, N₂O, N₂, NH₃ and CO₂ contribute to greenhouse gases, and to urea losses. While N makes up 78% of the atmosphere, few plants (for instance, legumes) are adapted to convert or “fix” N directly from the atmosphere to satisfy their need for N. Thus, plants rely on available forms of N (ammonium; NH₄ and nitrate; NO₃) from mineralization of organic soil N or the application of fertilizer N to optimize their growth and development. Crop production removes soil nutrients when crop outputs such as grain, straw, tubers, etc., are removed at harvest. The primary forms of N found in N fertilizers are ammonium (NH₄), nitrate (NO₃), and urea (CO(NH₂)₂) or combinations thereof. Plant availability and recovery of N from NH₄ or NH₄-forming fertilizers are reduced by N losses via leaching and runoff, denitrification, and ammonia (NH₃) volatilization. Gaseous N loss via NH₃ volatilization is a major potential pathway of loss. Therefore, NH₃ volatilization can potentially reduce a grower's economic return and have negative impacts on the environment.

Currently, there are some possible methods to try and reduce the greenhouse effect problem:
Using coated urea
Using slow release urea
Adding a nitrification inhibitor
Adding a Urease inhibitor
   or a combination all or part of the above, however, there is still a long felt need for a solution which allows for the fertilization of soil with an N-fertilizer, while still addressing the problem of ammonia volatilization.

### SUMMARY OF THE INVENTION

According to some embodiments, there is provided herein a cocrystal of Polyhalite and an N-fertilizer comprising DTA peaks at 115-125 and 202-220 degrees, and another endothermic peak at 345-380 degrees.

According to some embodiments, the cocrystal may further include another exothermic peak at 390-410 degrees.

According to some embodiments, the ratio between the Polyhalite and the N-fertilizer may be between 1:5 to 5:1.

According to some embodiments, the ratio may preferably be 1.5:1, respectively.

According to some embodiments, the cocrystal may comprise less than 10% wt of water at 75% RH after 50 hours from creation.

According to some embodiments, the N-fertilizer may be selected from the group including Nitrate salts, Ammonium salts, ammonium nitrate, calcium ammonium nitrate, magnesium ammonium nitrate, ammonium sulphate and ammonium phosphate.

According to some embodiments, the N-fertilizer may preferably be Urea

According to some embodiments, the cocrystal may further include (NH₄)₂HPO.

According to some embodiments, the cocrystal may further include (NH₄)₂SO₄.

According to some embodiments, the N-fertilizer may be (NH₄)₂SO.

According to some embodiments, there is provided herein a use of a cocrystal of Polyhalite and an N-fertilizer as a fertilizer for the reduction of ammonia emission, wherein the cocrystal may include DTA peaks at 115-125 and 202-220 degrees, and another endothermic peak at 345-380 degrees.

According to some embodiments, there is provided herein a process for the production of a cocrystal of Polyhalite and N-fertilizer by mixing stochiometric proportions of said Polyhalite and said N-fertilizer, wherein said cocrystal comprising DTA peaks at 115-125 and 202-220 degrees, and another endothermic peak at 345-380 degrees.

According to some embodiments, the ratio between the Polyhalite and the N-fertilizer in the process may preferably be 1:1.5, respectively.

According to some embodiments, the process may take place in a machine selected from the group including ball mill, beater mill, Eirich mixer or high shear mixer.

### DESCRIPTION OF THE DRAWINGS

FIG. 1 is a graph depicting the thermal analysis of a mixture of Polyhalite and urea, according to some embodiments.

FIG. 2 is a graph depicting the thermal analysis of Polyhalite

FIG. 3 is a graph depicting a graph demonstrating the water absorption of Urea, Melted urea with Polyhalite, mixture of Polyhalite and urea, Polyhalite, a cocrystal of polyhalite and urea, according to some embodiments.

FIG. 4 is a graph depicting the thermal analysis of a mixture of Polyhalite and (NH₄)₂SO₄, according to some embodiments.

FIG. 5 is a graph depicting the thermal analysis of a mixture of Polyhalite, urea and (NH₄)₂SO₄, according to some embodiments.

FIG. 6 is a graph depicting the thermal analysis of a mixture of Polyhalite and (NH₄)₂HPO₄, according to some embodiments.

FIG. 7 is a graph depicting the thermal analysis of a mixture of Polyhalite and lignite, according to some embodiments.

FIG. 8 is a graph depicting the thermal analysis of a mixture of Polyhalite, urea and lignite, according to some embodiments.

FIG. 9 is a SEM analysis of the cocrystal of the present invention, according to some embodiments.

FIG. 10 is a graph depicting the water adsorption at 75% RH of polyhalite alone, in comparison to the water absorption of: polyhalite with (NH₄)₂SO₄ ball milled for 8 hours; polyhalite with (NH₄)₂SO₄ ball milled for 2 hours and polyhalite with (NH₄)₂SO₄ ball milled for 4 hours, in accordance with some embodiments.

FIGS. 11 and 12 show a graph depicting nitrogen loss, in accordance with some embodiments.

FIG. 13 is a graph depicting the TGA, DTA of granules of the present invention in accordance with some demonstrative embodiments.

FIG. 14 is a graph depicting the TGA, DTA of granules of the present invention in accordance with some demonstrative embodiments.

FIG. 15 is a graph depicting the decomposition of pure urea at various temperatures, in accordance with some demonstrative embodiments.

FIG. 16 depicts the mass spectrometry (MS) decomposition of cocrystal, in accordance with some demonstrative embodiments.

FIG. 17 is a graph depicting the thermal decomposition of Polyhalite, in accordance with some demonstrative embodiments.

FIG. 18 is a graph depicting the TGA, DTA and DTG curves for urea, according to some embodiments.

FIG. 19 is a graph of overlapping of the DTA and TG signals obtained by the thermal decomposition of the individual substances, according to some embodiments.

FIG. 20 is a graph of the DTA and TG of a cocrystal of the present invention, according to some embodiments.

FIG. 21 depicts DTA graphs of 3 cocrystals of the present invention, in accordance with some demonstrative embodiments.

FIG. 22 depicts DTA graphs of 3 cocrystals of the present invention, in accordance with some demonstrative embodiments.

FIG. 23 depicts a graph of thermal degradation of various cocrystal samples, in accordance with some demonstrative embodiments.

FIG. 24 depicts DTA/TG graphs of a cocrystal of the present invention, in accordance with some demonstrative embodiments.

FIG. 25 depicts DTA and TG graphs of a cocrystal, in accordance with some demonstrative embodiments.

FIG. 26 depicts DTA and TG graphs of a cocrystal, in accordance with some demonstrative embodiments.

FIG. 27 depicts the DTA and TG graphs of a CaSO₄-urea adduct in accordance with some demonstrative embodiments.

FIG. 28 depicts the DTA and TG graphs of a cocrystal, in accordance with some demonstrative embodiments.

FIG. 29 depicts a graph of the DTA and TG of (NH₄)₂SO₄, in accordance with some demonstrative embodiments.

FIG. 30 is a graph of DTA/TG of (NH₄)₂SO₄ in comparison to Polyhalite/(NH₄)₂SO₄ mixtures in accordance with some demonstrative embodiments.

FIG. 31 depicts a graph of DTA/TG of (NH₄)₂HPO₄, in accordance with some demonstrative embodiments.

FIG. 32 depicts the DTA and TG graph of a cocrystal, in accordance with some demonstrative embodiments.

FIG. 33 depicts the DTA and TG graphs of a cocrystal in accordance with some demonstrative embodiments.

FIG. 34 depicts a DTA and TG graphs of NH₄H₂PO₄ in accordance with some demonstrative embodiments.

FIG. 35 depicts a graph of the DTA and TG of a cocrystal, in accordance with some demonstrative embodiments.

FIG. 36 depicts a graph showing the DTA and TG of examples 28 and 29 in a single graph, in accordance with some demonstrative embodiments.

FIG. 37 depicts a graph comparing different cocrystals, in accordance with some demonstrative embodiments.

FIG. 38 depicts a graph demonstrating the volatilization of different formulations, in accordance with some demonstrative embodiments.

### DETAILED DESCRIPTION OF THE INVENTION

According to some demonstrative embodiments, there is provided herein a cocrystal of an N-fertilizer and Polyhalite.

According to some embodiments, the cocrystal is produced using mechanochemistry, e.g., ball milling, high shear mixing and the like.

According to some embodiments, the term “cocrystal(s)” may refer to any suitable solids that are crystalline single phase materials originally composed of two or more different molecular or ionic compounds generally in a stoichiometric ratio which are neither solvates nor simple salts.

According to some embodiments, the term “mechanochemistry” may refer to the phenomena of coupling of mechanical and chemical processes on a molecular scale and includes mechanical breakage, chemical behavior of mechanically stressed solids.

Mechanochemistry is believed to be the interface between chemistry and mechanical engineering. It is possible to synthesize chemical products by using only mechanical action.

According to some embodiments, the cocrystal of the present invention can be produced by using manual blending and grinding, a ball mill, high shear mixing or in a plough shear mixer beater mill and the like.

According to some demonstrative embodiments, the cocrystal of the present invention may preferably be produced by using ball milling, as the grinding process thereof is most preferable for enabling a larger surface area for both the Polyhalite and nitrogen fertilizer.

According to some demonstrative embodiments, there is provided herein a cocrystal of Polyhalite and an N-fertilizer, in a ratio of 5:1 to 1:1, preferably, 3.5:1, most preferably: 1.5:1.

According to some embodiments, it is to be understood that when referring to an N-fertilizer, the cocrystal of the present invention may include more than one fertilizer, for example, two or more N-fertilizerd mixed together. For example, urea mixed with (NH₄)₂SO₄.

According to some demonstrative embodiments, the cocrystal of the present invention may exhibit characteristics which are not present in a plain mixture of an N-fertilizer such as Urea with Polyhalite, including, for example, the water absorption, crystal formation and the like.

According to some demonstrative embodiments, the cocrystal may contain less than 10% wt of water at 75% RH after 50 hours from creation.

According to some embodiments, a Polyhalite mineral and a nitrogen fertilizer may be mixed in a ball mill to form a cocrystal product. The resulting product may be analyzed and/or characterized by thermal analysis and/or water absorption, for example a SEM.

According to some embodiments, phosphate fertilizers may be added to the Polyhalite mineral and a nitrogen fertilizer before mixing for producing a cocrystal fertilizer capable of providing a plant with N, P, K, S, Ca, Mg. According to some embodiments, the cocrystal fertilizer granule may also include additional substances, for example, for absorbing water, such as lignite and the like.

According to some embodiments, the granule may also include herbicides, bacteriocidic and/or bacteriostatic substances.

According to some embodiments, an additive may be added to the cocrystal inhibitors to reduce ammonia emission like brown coal (lignite), thiosulphate salts, zinc salts.

According to some embodiments, a binder can be added like starch, silicate, geopolymers or lignite.

According to some embodiments, adding lignite and/or gypsum may increase the efficiency of the fertilizers, as well as acting as a water and micronutrient absorber and can reduce ammonia emission.

According to some embodiments, one or more micronutrients like micronutrients: copper (Cu), iron (Fe), manganese (Mn), molybdenum (Mo), zinc (Zn), boron (B), and of occasional significance there are silicon (Si), cobalt (Co), and vanadium (V)

According to some embodiments, there is provided herein a process for the production of a cocrystal fertilizer including the steps:
1. Drying a Polyhalite mineral and a nitrogen fertilizer.
2. Mixing the dry Polyhalite mineral and the dry nitrogen fertilizer in a ball mill to provide a powder of cocrystal.
3. Optionally adding additives to the ball milling process, such as ammonia emission inhibitors, glidants, binders and the like.
4. Optionally, the cocrystal can be produced using high shear in a single step.

According to some embodiments, Urea and other NH₄-forming fertilizers are commonly used to optimize crop production, but are susceptible to losses of more than 50% as NH₃ gas, particularly when left on the soil surface after application. Ammonia volatilization results in loss of applied nutrients, which can negatively impact farm economy and the environment. According to some embodiments, the unique combination of Polyhalite and and N-fertilizer, e.g., urea, as described herein, allows for the creation of a cocrystal having specific characteristics, including, for example, diminishment in Ammonia volatilization.

According to some embodiments, the cocrystal formed according to the present invention allows for the entrapment of the NH₄ portion within the fertilizer.

According to some embodiments, the surprising effect of such entrapment may utilize an inhibiting mechanism, the nature of which can only be estimated at this stage.

According to some embodiments, Sulfate-reducing bacteria (SRB), which may be present in the soil may facilitate the conversion of sulfate to sulfide.

According to some embodiments, the exposure of Polyhalite to SRB may result in the formation of sulfide, which in turn may act a urease inhibitor.

According to some embodiments, due to loss of material during the reduction process, the concentration or amount of Polyhalite should preferably be higher in comparison to the concentration or amount of the N-fertilizer.

According to some demonstrative embodiments, there is provided herein a cocrystal of Polyhalite and an N-fertilizer, in a ratio of 5:1 to 1:1, preferably 3.5:1, and most preferably: 1.5:1.

According to some embodiments, a Polyhalite mineral and a nitrogen fertilizer may be mixed in a mixer, e.g., high shear mixer or -plough shear According to some embodiments, the mixed Polyhalite and urea can be transferred to a ball mill or a granulation machine e.g., an EIRICH, beater mill, plough share to produce cocrystal in a single step and result in a fast reaction.

According to some embodiments, the granular cocrystal of the present invention may be produced by single step, including, for example, mixing Polyhalite and urea in a ball-mill or an Eirich mixer at high speed, e.g., 2500-3000 RPM—for 30 second and then reducing the mixing to 300-700 RPM to form cocrystal granules.

According to some embodiments, the cocrystal of the present invention may be produced via a quick single step, including, for example, by mixing Polyhalite and urea in a ball mill or a beater mill at high speed, 5000 RPM for 2-10 minutes.

The resulting granular cocrystal of Polyhalite mineral and a nitrogen fertilizer may be tested to estimate the ammonia emission in the soil, as described in the examples and figures of this application.

According to some embodiments, cocrystal granules of Polyhalite mineral and a nitrogen fertilizer may be produced using press granulation.

According to some embodiments, phosphate fertilizers may be added to the Polyhalite mineral and a nitrogen fertilizer before mixing for producing a cocrystal fertilizer capable of providing a plant with N, P, K, S, K, Mg, micronutrients. According to some embodiments, the cocrystal fertilizer granule may also include additional substances, for example, for absorbing water, such as lignite etc.

According to some embodiments, the specific use of a water absorbing substance, e.g., lignite, may enhance the water absorbing capabilities of the cocrystal of the present invention.

According to some embodiments, the cocrystal fertilizer granule may also include additional substances, for example, for increasing the process efficiency, like gypsum, lignite and the like.

According to some embodiments, the granule may also include herbicides, bacteriocidic and/or bacteriostatic substances.

According to some embodiments, an additive may be added to the cocrystal inhibitors to reduce ammonia emission, e.g., brown coal (lignite).

According to some embodiments, a binder can be added like starch; silicate, geopolymers or lignite.

According to some embodiments, adding lignite can increase the efficiency of the fertilizers, as well as acting as a water and micronutrient absorber and can reduce ammonia emission.

According to some embodiments, one or more micronutrients like micronutrients: copper (Cu), iron (Fe), manganese (Mn), molybdenum (Mo), zinc (Zn), boron (B), and of occasional significance there are silicon (Si), cobalt (Co), and vanadium (V)

According to some embodiments, there is provided herein a process for the production of a cocrystal fertilizer granules of Polyhalite and urea with a wide range of Polyhalite particle sizes—from 2 mm up to 4 mm. According to some embodiments, this size range is preferable as it provides for the grinding results, for example, when used in a ball mill (due to quick achievement of the desired surface area).

According to some embodiments, there is provided herein a process for the production of a cocrystal fertilizer granules 2-4.7 mm of Polyhalite and urea in molecular proportion 1:5 to 5:1 in a single step, e.g., a fast step that takes a few minutes.

According to some embodiments, the ratio between the urea and Polyhalite may be 5:1 to 1:5, preferably 1:3.5, most preferably 1:1.5, respectively.

According to some embodiments, the cocrystal of the present invention may preferably be formed in a machine selected from the group including Ball mill, Eirich mixer and beater mill, plough shear. According to some embodiments, these devices may enable the formation of the cocrystal in a single step.

According to some demonstrative embodiments, the cocrystal of the present invention may comprise Polyhalite and Ammonium Sulphate, Mono Ammonium Phosphate (MAP) and/or Di Ammonium Phosphate (DAP).

According to some embodiments, the mechanochemical reaction between Polyhalite, Ammonium Sulphate, MAP and/or DAP may change the properties of Polyhalite, and this is exemplified in the examples and figures of the present invention.

According to some demonstrative embodiments, various cocrystals may be produced by using the combination of the N-fertilizer with suitable fertilizers such as Potassium Sulphate, Kieserite and the like. According to some embodiments, these cocrystals may present a lower emission of Ammonia.

According to some embodiments, the N-fertilizer may be selected from the group including Urea, Nitrate salts, Ammonium salts, ammonium nitrate, calcium ammonium nitrate, magnesium ammonium nitrate, ammonium sulphate and ammonium phosphate.

### Experiments

Polyhalite mineral may be dried at 80 degrees and mixed with other components in a ball mill at room temperature.

The mill may contain 40 balls and rotate at 300 RPM.

A sample of the product may be taken to thermal analysis, and measure water absorption.

### EXAMPLES

### Example—1

400 gr of Polyhalite were mixed with 160 gr urea (molecular proportion 2.5:1, respectively) for 6 hours in a ball mill, at room temperature.

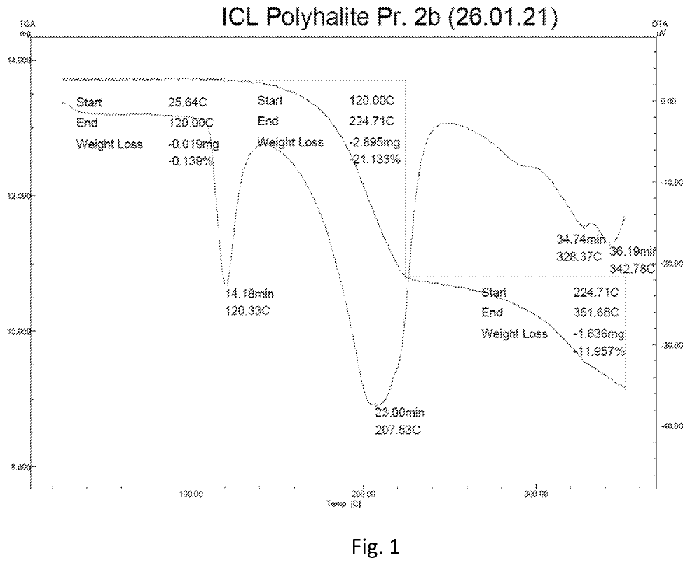

Reference is made to FIG. 1 which depicts a graph showing the thermal analysis of the product of example 1.

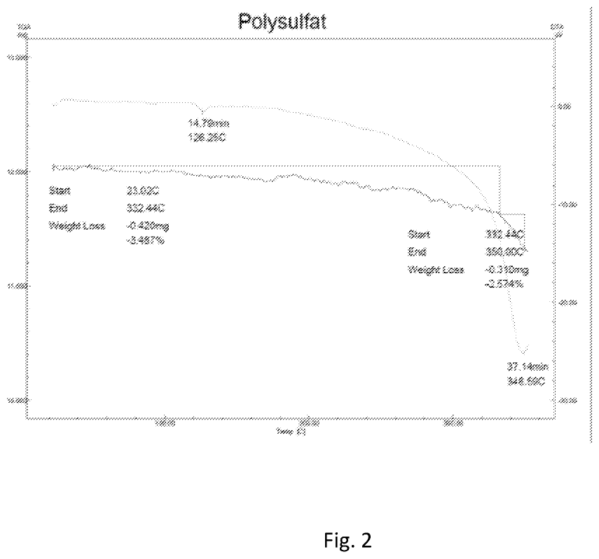

As shown in FIG. 1 and FIG. 2 there is a difference between the DTA and TGA of polyhalite and the DTA and TGA cocrystal of polyhalite with urea.

This already demonstrates that the cocrystal is a new substance having different characteristics than Polyhalite and urea separately.

Reference is made to FIG. 2, which depicts a graph of the thermal analysis of Polyhalite.

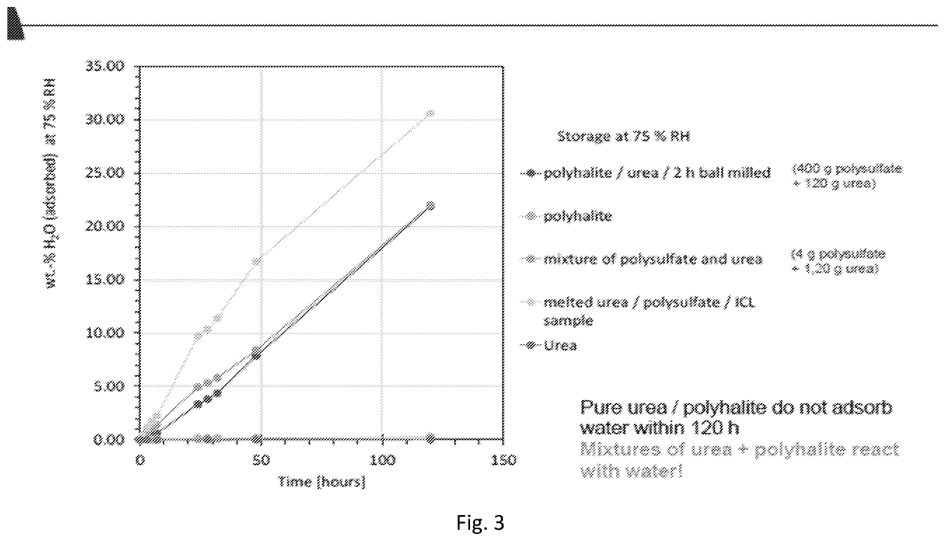

Reference is made to FIG. 3, which depicts a graph demonstrating the water absorption difference of various products:
1. Urea
2. Melted urea with Polyhalite
3. Mixture of Polyhalite and urea
4. Polyhalite
5. A cocrystal of Polyhalite and urea (after being subjected to a ball milling process).

The water absorption of these products was conducted at 75% RH humidity conditions.

As can be seen from FIG. 3 the cocrystal of Polyhalite and urea did not absorb a lot of water even after 120 hours in comparison to the plain mixture of Polyhalite and urea (product 3) which did absorb higher quantities of water.

Specifically, according to some demonstrative embodiments, the cocrystal of the present invention may contain less than 10% wt of water at 75% RH after 50 hours from creation.

FIG. 3 exemplifies a cocrystal of the present invention having a ratio of Polyhalite to Urea of 400:120 (3.3:1, respectively)

As can be seen in FIG. 1 and FIG. 2 there might be a peak of cocrystal at around 210 degrees. Also there might be a peak at around 345-400 degrees.

However, the cocrystal is the only substance that has both peaks at both around 210 and 345, and also, as can be seen in some of the graphs below, has another peak at around exothermic peak at 370-410 degrees.

According to some embodiments, the cocrystal of Polyhalite and an N-fertilizer comprises DTA peaks at 115-125 (urea melting) and 202-220 degrees and an endothermic peak at 345-370 degrees.

The cocrystal may further include another peak, an exothermic peak at 370-410 degrees.

### Example 2

400 gr of Polyhalite was mixed with 80 gr of (NH₄)₂SO₄ for 8 hours in a ball mill at room temperature.

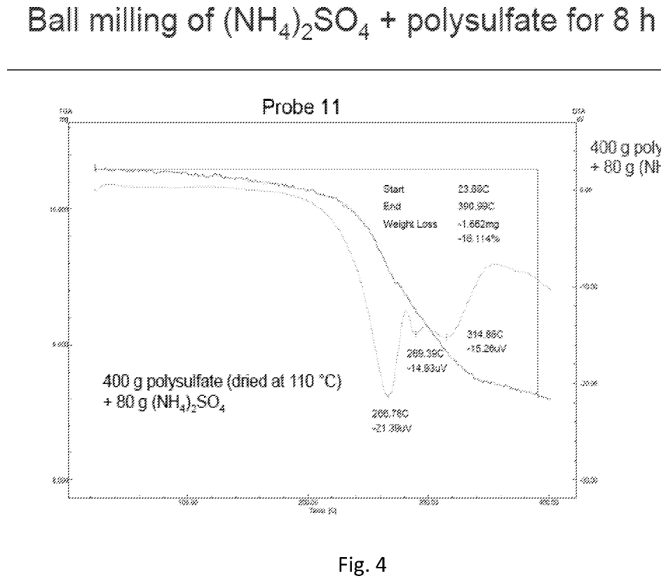

Reference is made to FIG. 4 which depicts a graph showing the thermal analysis of the product of example 2.

As shown in FIG. 4 the DTA/TGA of the adduct is different from the DTA/TGA of Polyhalite a peak appear at 266 degree. But we cannot ignore that we get adduct of ammonium sulphate calcium sulphate.

### Example 3

400 gr of Polyhalite were mixed with 120 gr urea and 80 gr of (NH₄)₂SO₄ in a ball mill for 6 hours at room temperature (a ratio of 2:1, Polyhalite to mixture of N-fertilizer, respectively).

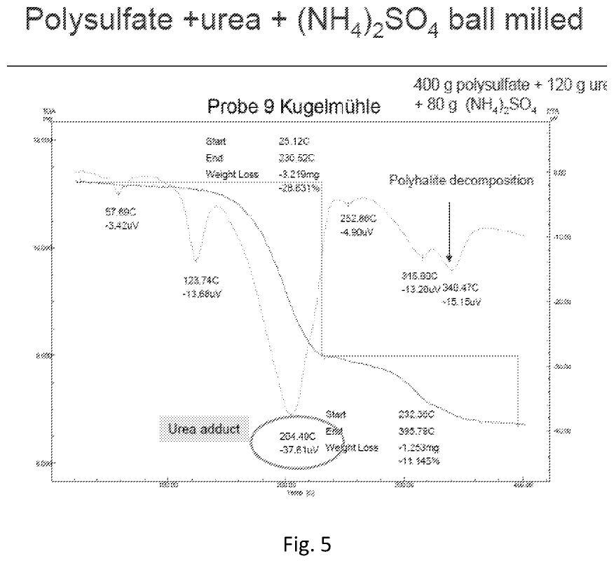

Reference is made to FIG. 5 which depicts a graph showing the thermal analysis of the product of example 3.

As shown in FIG. 5—two peaks at 123 degree and 204. The first peak refers to the melting of urea and the peak at 204 degrees refers to the polyhalite-urea cocrystal.

### Example 4

400 gr of Polyhalite were mixed with 80 gr of (NH₄)₂HPO₄ (ratio of 5:1, respectively) in a ball mill for 6 hours at room temperature.

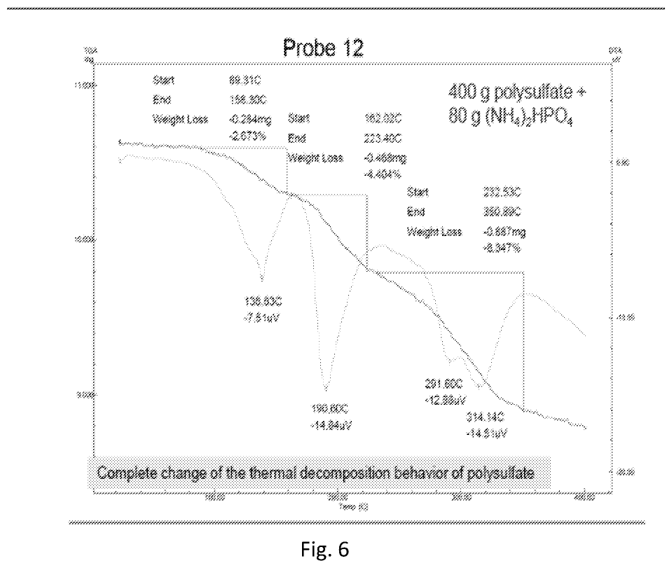

Reference is made to FIG. 6 which depicts a graph showing the thermal analysis of the product of example 4.

As shown in FIG. 6 the formed cocrystal exhibits new peaks which are different than the peaks of Polyhalite alone.

Also, the water absorption of the adduct Polyhalite with (NH₄)₂HPO₄ and the DTA/GTA indicate that a new cocrystal is formed.

### Example 5

400 gr of Polyhalite were mixed with 100 gr of lignite (ratio of 4:1, respectively) at room temperature for 4 hours.

Lignite is a natural additive that can reduce ammonia emission from urea decomposition

Lignite can act as a binder of water during the reaction of polyhalite with other components during milling.

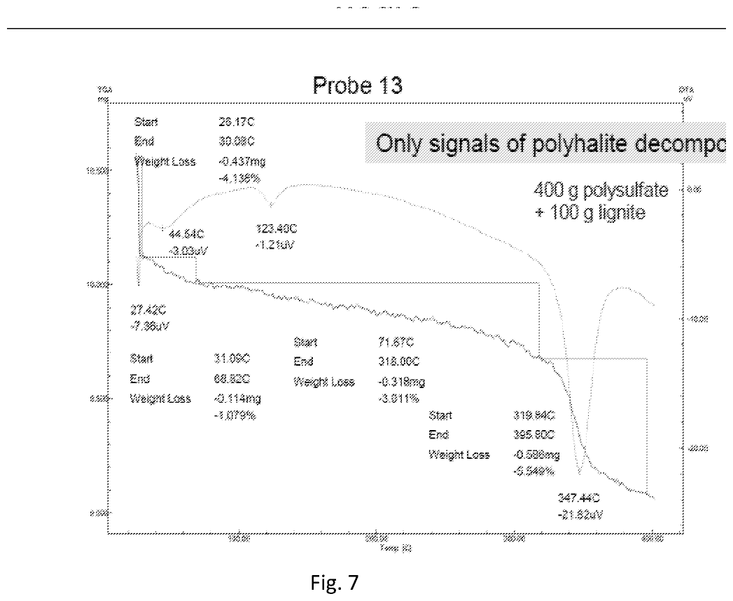

Reference is made to FIG. 7 which depicts a graph showing the thermal analysis of the product of example 5.

As shown in FIG. 7 the composition of polyhalite and lignite there is no difference to polyhalite only.

### Example 6

400 gr of polyhalite were mixed with 120 gr urea and 60 gr of lignite in a ball mill for 4 hours at room temperature.

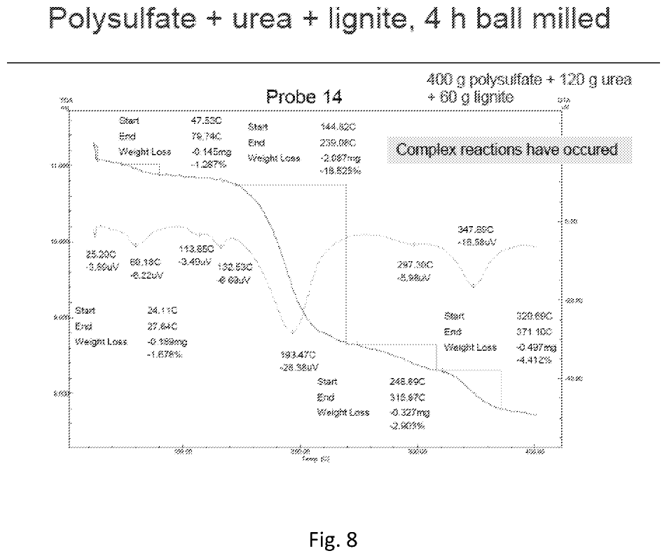

Reference is made to FIG. 8 which depicts a graph showing the thermal analysis of the product of example 6.

As shown in FIG. 8 upon comparison to FIG. 7 it is evident that the DTA/GTA is different. This difference indicates that a new cocrystal is formed by milling polyhalite urea and lignite.

FIG. 8 demonstrates the existence of a complex reaction between the polyhalite, urea and lignite, and the new peaks at 193 degrees indicate the formation of new product rather than a plain mix between polyhalite, urea and lignite.

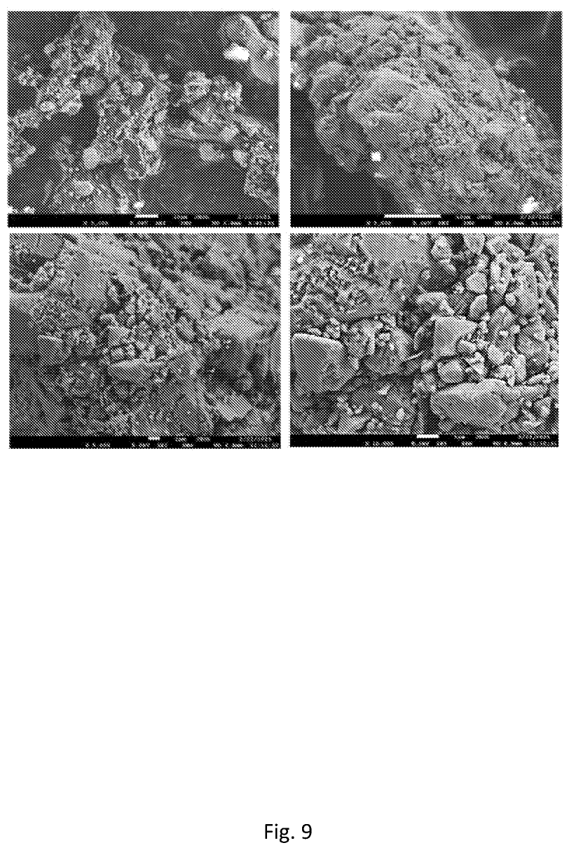

Reference is now made to FIG. 9 which is a SEM analysis of the cocrystal of the present invention.

As can be seen from FIG. 9, the SEM analysis of polyhalite and urea cocrystal prepared by ball milling, it can be seen that there is homogeneous interaction rather than two separate components.

All the above indicates that milling of Polyhalite and urea formed cocrystal of Polyhalite-urea which has different properties than plain mixing of Polyhalite and urea.

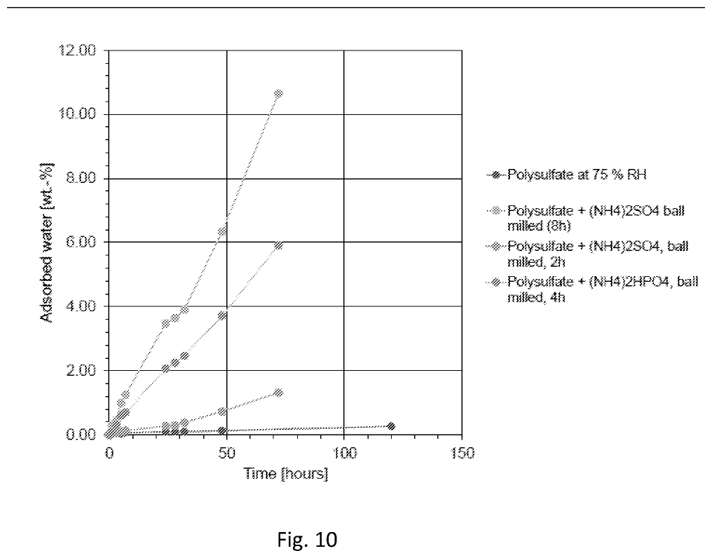

Reference is made to FIG. 10 which depicts a graph showing the water adsorption at 75% RH of
1. Polyhalite alone,
   in comparison to the water absorption of:
2. Polyhalite with (NH₄)₂SO₄ ball milled for 8 hours
3. Polyhalite with (NH₄)₂SO₄ ball milled for 2 hours
4. Polyhalite with (NH₄)₂HPO₄ ball milled for 4 hours

As can be seen in FIG. 10, Polyhalite did not absorb water at 75% humidity, whereas the Cocrystal of Polyhalite after 2 hours of milling absorbed about 0.655 water. Milling for 8 hours show that the absorption of water of cocrystal of Polyhalite and ammonium sulphate is much higher due to finer particle size.

As can be seen from FIG. 10, various cocrystals created according to the present invention contained less than 10% of water absorbed at 75% RH after 50 hours from creation.

### Example 8

Determination of ammonia volatilization of urea based fertilizers on a soil medium using a volatilization chamber.

### Principle:

It is known that when urea is applied to soil, under certain conditions, there will be a loss in, for the plant available, nitrogen. Part of the nitrogen is lost as ammonia gas.

This method can be used to determine the amount of nitrogen loss due to ammonia volatilization. The ammonia gas will be captured using acid which converts the ammonia (gas) into the ammonium ion (liquid), which can be measured using different analytical methods.

### Reagents/Chemicals:

H₂SO₄ 0.2N
130 g soil, <2 mm
Reversed Osmosis (RO) water

### Equipment:

Balance
Volatilization chamber (see picture, air pump, 2×500 ml gas washing bottles, 1× gas scrubber (glass) min. volume of 250 ml=Acid trap, hoses and connectors to connect the different parts of the volatilization chamber)
100 ml volumetric flask with stopper
Graduated cylinder 50 ml
Washing bottle with RO water
Pipette
Funnel
Sieve 2 mm
Auto Analyzer (NPK determination)

### Procedure:

Fill the acid trap with 50 ml H₂SO₄ 0.2N
Fill the first gas washing bottle with water
Fill the second gas washing bottle with 130 g soil (<2 mm) and add the sample(*) to be tested.
(be sure that all the different parts are connected before switching on the air pump)
Switch air pump on.
After set time interval switch off the air pump and close the valve leading to the acid trap.
Transfer the solution from the acid trap into a 100 ml volumetric flask and fill to the 100 ml mark with RO water. This solution will be used for the determination of the nitrogen content (N—NH4+).
Fill the acid trap with 50 ml H₂SO₄ 0.2N reconnect the acid trap open valve and turn the air pump on.
Repeat this procedure as long as necessary.

(*)=The amount of sample depends on the amount of urea in the sample.

Using this method, the sample should contain 0.4 g of urea.

### Remarks:

The soil used had a pH of +5 (determined using the method with 1M KCl).
In every test series a blank and a reference, containing 0.4 g urea (mini prills or powder) should be included.
Also, urea based liquids can be tested.
The picture shows the addition of a methyl red indicator to the H₂SO₄ 0.2N (if during the test a color change to yellow will occur means no NH₃ can be captured anymore giving wrong results).
For this set up readings were 3 times a week, depending on the results this frequency can be lowered.

### Example 9

Laboratory ammonia volatilization test of polyhalite-urea co-crystal samples on soil

### Principle:

It is known that when urea is applied to soil, under certain conditions, there will be a loss in, for the plant available, nitrogen. Part of the nitrogen is lost as ammonia (NH₃) gas. The method used determines the amount of nitrogen loss due to ammonia volatilization. The ammonia gas will be capture using acid which converts the ammonia (gas) into the ammonium ion (liquid), which can be measured using different analytical methods.

Samples tested:
Polyhalite-urea co-crystal powder—60:40
Polyhalite-urea co-crystal granular (60:40)
Urea (mini prills) reference—
Medium: soil<2 mm, pH 5

### Test Set-Up:

The acid trap solution is analyzed for the nitrogen content, which equals the loss of nitrogen through NH₃ (gas) volatilization.

### Discussion and Analysis of Result

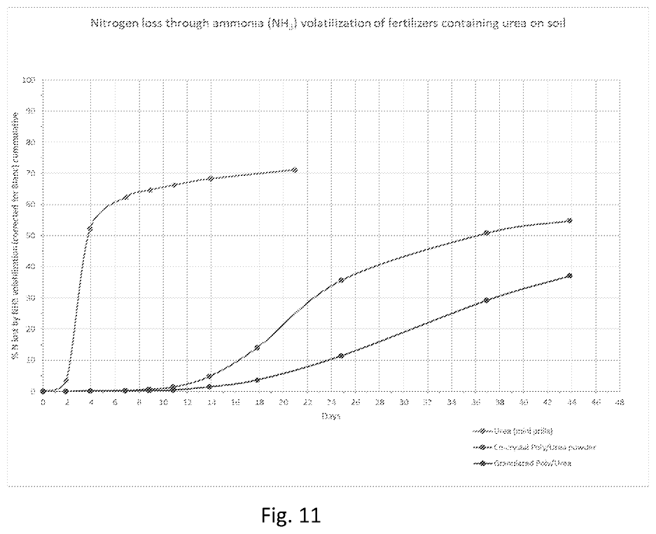

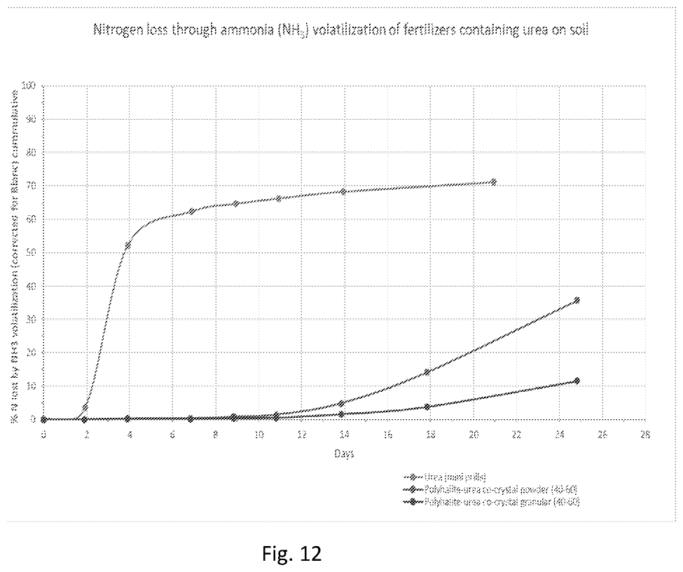

Reference is now made to FIGS. 11 and 12, which depict the same experiment held for 44 days and 24 days, respectively. The intermediate laboratory test results are showing an improved nutrient use efficiency of the nitrogen compound of the urea based polyhalite-urea co-crystal samples (powder and granules) compared to urea mini prills. As seen in the graphs, when urea is applied on the medium used in this test, most of the nitrogen is lost within only a couple of days. On the other hand, the two polyhalite-urea co-crystal samples are showing less loss of nitrogen, especially in the first 2 weeks. Also, after 2 weeks the curve of the nitrogen loss is not as steep as seen when urea is used. Another effect is that granules are showing less nitrogen loss compared to the powder (powder has more surface area resulting in better contact of the water soluble part of the product with moisture, which give increase in solubility and in this case somewhat more nitrogen loss). As shown in FIGS. 11 and 12, the gas emission is close to linear shape as a function of time, which means the emission can be estimated assuming this curve continues in the same way.

### Example 10—Producing Granular Polyhalite-Urea Cocrystal in a Single Step

1. Mixing the Polyhalite mineral and the nitrogen fertilizer in a an Eirich mixer to provide a powder of cocrystal.
2. Optionally adding additives to the Eirich process, such as ammonia emission inhibitors, glidants, binders and the like.
3. Optionally pelletizing the cocrystal powder to granule.
4. Eirich mixer mixed at about 2700 RPM at high temperature until the urea is melted
5. Eirich mixer speed reduce to 500 rpm
6. the resulting granules are screened to 2-4.7 mm and sent to mechanical analysis and ammonia emission.

### Example 11

Polyhalite and urea were mixed in a 60:40 proportion in an Eirich mixer at 2700 rpm and about 110 C. degree for 10-45 minutes, after which the mixer speed was reduced to 500 rpm until the granules cooled down. The granules were screened to a size 2-4.7 mm and sent to analysis.

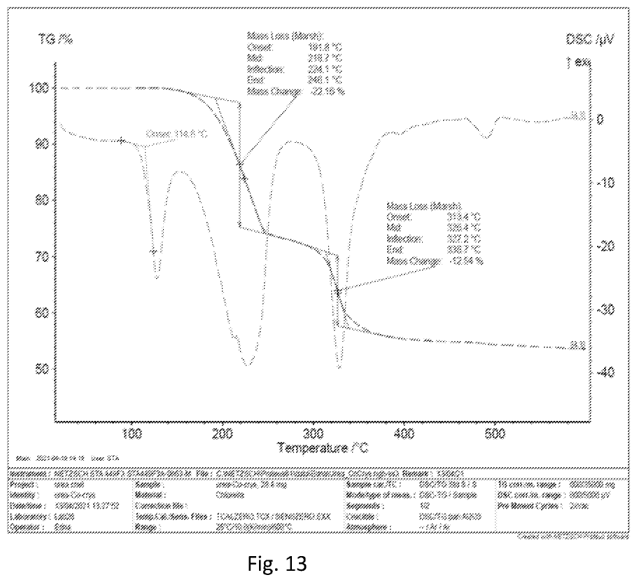

See FIG. 13 depicting the TGA, DTA of granules of example 11.

From the above graph we can see peaks in the same range of polyhalite-urea cocrystal.

### Example 12

Same as in example 11

The product screened to 2-4.75 mm fraction and was sent to mechanical analysis, thermal analysis and ammonia emission analysis:
PSD of granules 2-4.75 mm
Granules strength 5.5 Kg/granules
Abrasion—0.12%—100 mesh
Eco dust 0.05%

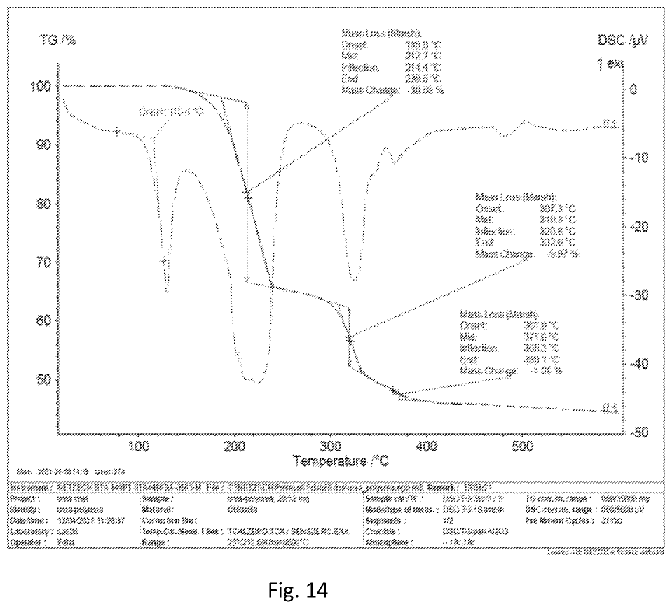

FIG. 14 is a graph depicting the TGA, DTA of granules of example 12.

### Example 13

### Polyhalite-Urea Co-Crystal Ammonia Emission in Soil

Three samples tested
1. Polyhalite-urea Cocrystal
2. Urea prills
3. Polyhalite-urea ground cocrystal

The Polyhalite-urea co-crystal sample showed no loss of nitrogen, especially in the first 11 days. After 2 weeks the nitrogen loss in cocrystal was much less than the emission from urea. After two weeks only about 30% of the original N value quantity remains in the urea in comparison to about 90% in the coarse Polyhalite-urea cocrystal and about 65% in the grinded cocrystal.

After 44 days still more than 60% of urea value remained in the granular polyhalite-urea cocrystal. It seems that the ammonia emission from the polyhalite-urea cocrystal is linear as a function of time. From the graph we can estimate that granular co crystal (after about 10 days) loss 1% of N value per day

### Example 14—Identifying the Emission Gases

1. Two samples were tested: Pure Urea; cocrystal of polyhalite urea
2. The tests include TGA, DSC and EVG. The analysis was carried out between RT-600° C. utilizing Netsch 449 F3 combined with Balzers QMS operating in a continuous mode, with α-Al₂O₃ crucible.
3. The measurements were carried out by continuous mode to 600° C. in 10° C./min in Ar atmosphere

### MS Decomposition of Urea

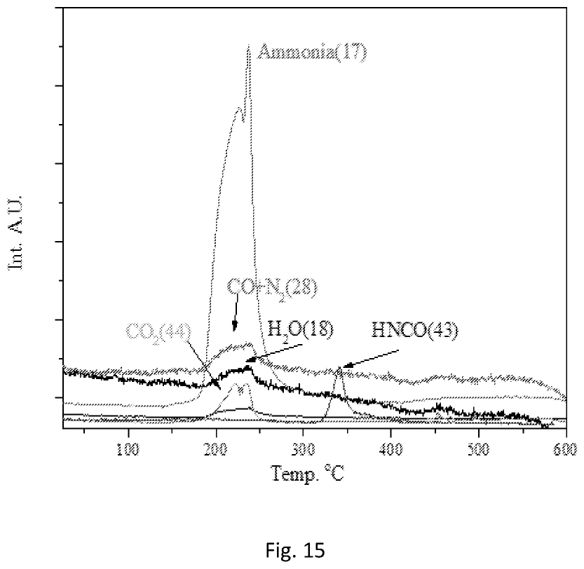

FIG. 15 depicts the decomposition of pure urea at various temperatures. The first mass loss at about 200° C. is associated with the ammonia release, while the second one at about 340° C. is the release of HNCO. In addition, there are water and CO and CO₂ that release.

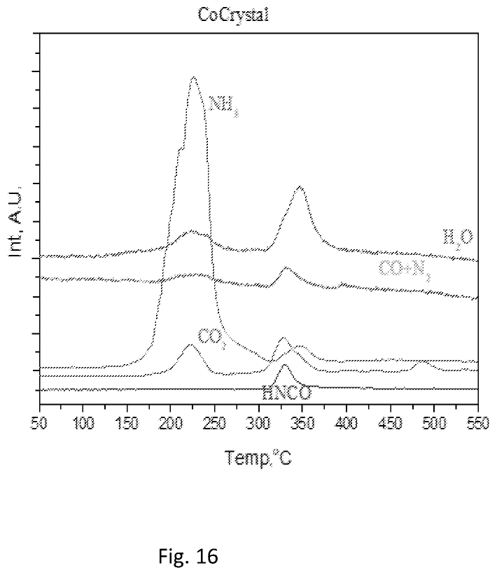

FIG. 16 depicts the mass spectrometry (MS) decomposition of cocrystal

The first endo peak is of a phase change that does not release any gas, as supported by the EVG analysis The large mass loss of about 20% at about 200° C. is of ammonia and CO₂. The second mass loss of approximately 12.5% at 300° C. is related to the second decomposition of the cocrystal, mainly with water, CO, CO₂ and HNCO.

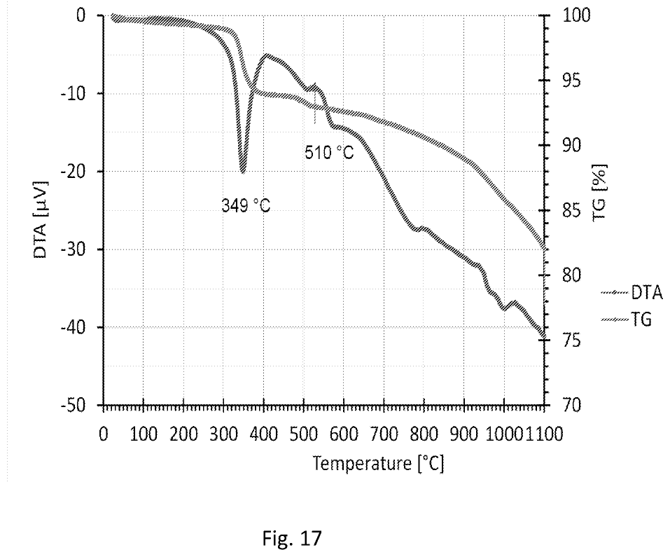

Reference is now made to FIG. 17 which is a graph depicting the thermal decomposition of polyhalite until 1100° C., according to some embodiments. As can be seen from FIG. 17, when heating is carried out until 1,100° C. continuous decomposition takes place.

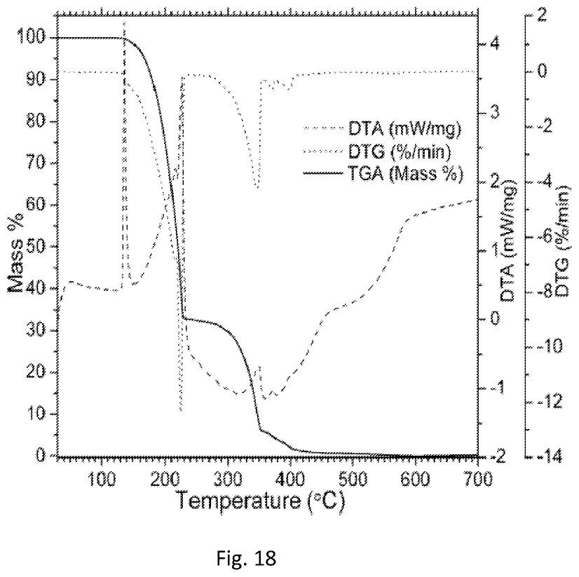

In contrast to that, the thermal decomposition of urea bases on very complex reactions, which depend strongly on the conditions. It is a complex process characterized by several steps in which polymerization and decomposition overall. A typical DTA/TG signals found by a thermal treatment are provided in FIG. 18.

FIG. 18 is a graph depicting the TGA, DTA and DTG curves for urea as a function of temperature and a Helium flow at 80 cm³ min⁻¹, at a heating rate of 5° C. min⁻¹, according to some embodiments.

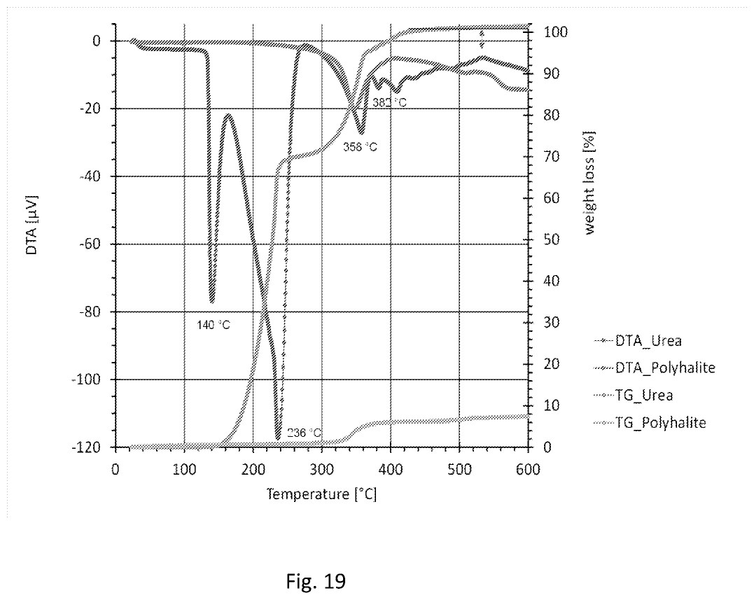

FIG. 19 is a graph of overlapping of the DTA and TG signals obtained by the thermal decomposition of the individual substances, according to some embodiments.

As shown in FIG. 19, the decomposition of polyhalite into langbeinite takes place in the same temperature range as the second step of urea decomposition, at around 360° C.

### Example 15

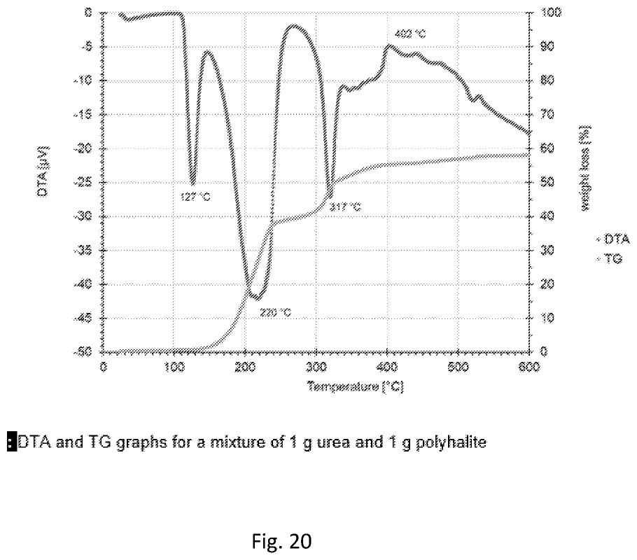

Reference is now made to FIG. 20 which depicts a graph of the DTA and TG of a cocrystal formed from a mixture of 1 gr Polyhalite and 1 gr of urea, according to some embodiments.

As can be seen from graph 20, the cocrystal has peaks at 127° C., 220° C., 317° C. and 402° C.

### Example 16

### Using Beater Mill to Produce Fast Cocrystal

Polyhalite-urea adducts were produced whereas a beater mill was used for the mechanochemical treatment of the urea-polyhalite mixtures.

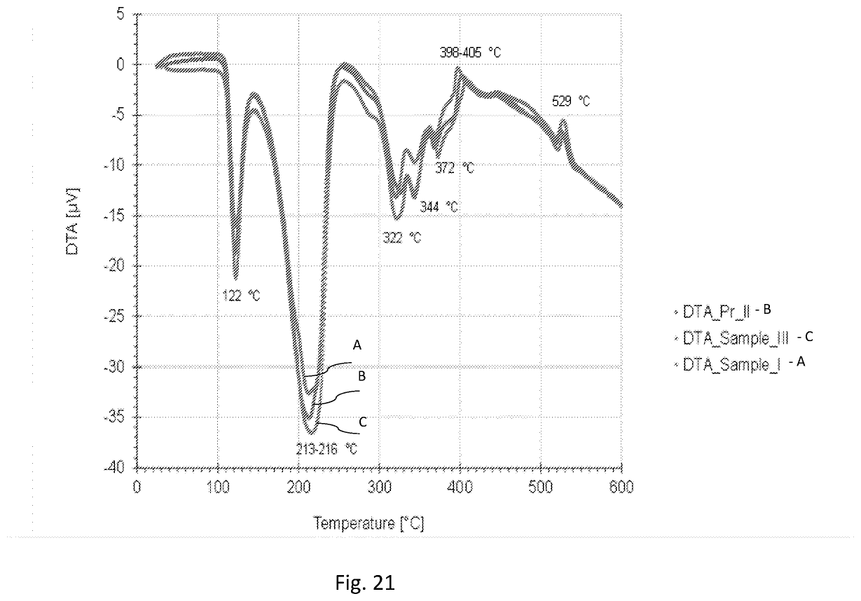

Reference is now made to FIG. 21 which depicts DTA graphs of 3 mixtures, i.e., cocrystals, (marked as samples I, II and III, marked as A, B and C, respectively) of 5 g Polyhalite and 4 g urea (molar ratio 1:8) after treatment in a beater mill for 2, 5 or 10 minutes, respectively.

As can be seen in FIG. 21, in short times, the cocrystal demonstrates the typical signals of CaSO₄-urea adducts. Already two minutes were sufficient for that, as the typical signals for urea adducts are at ˜370° C. and ˜400° ° C.

### Example 17

### As Example 16

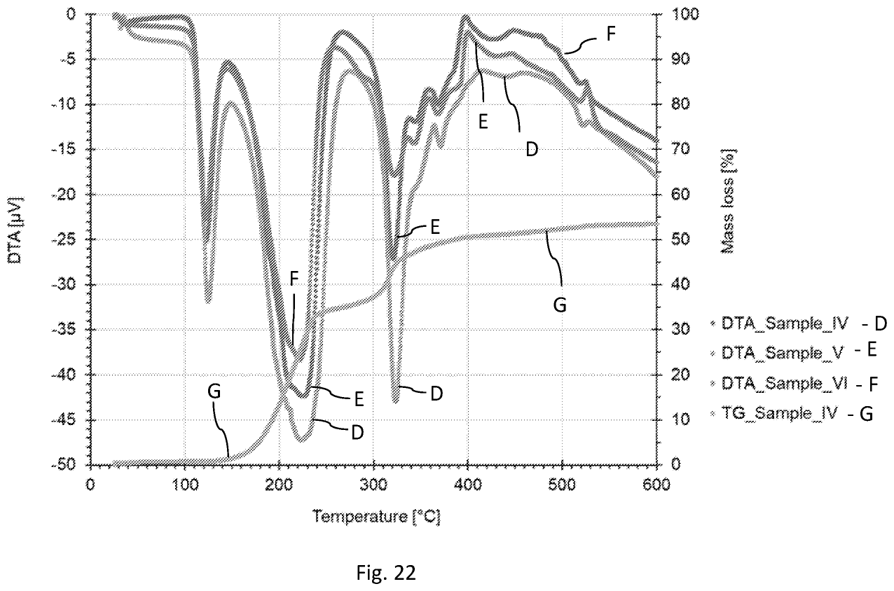

Reference is now made to FIG. 22 which depicts DTA graphs of 3 mixtures, i.e., cocrystals (marked as samples IV—Marked as D, treated for 10 minutes; Example V marked as E treated for 5 minutes and Sample VI marked as F treated for 2 minutes) of 5 g Polyhalite and 5 g urea (molar ratio 1:10) after treatment in the beater mill for 2, 5 or 10 minutes, as explained hereinabove.

The graph also depicts the TG of sample IV, marked therein as G.

It is evident that the cocrystal of the present invention may be formed rapidly at room temperature.

### Example 18

The efficiency of the reaction can potentially be increased by adding additives like lignite. This was tested in Example 18.

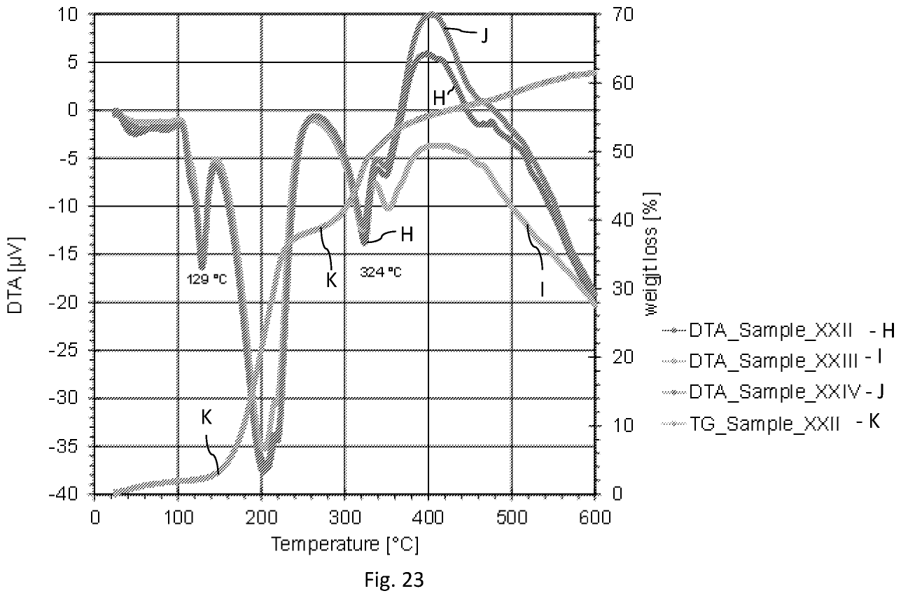

Reference is now made to FIG. 23, which depicts a graph of thermal degradation of various cocrystal samples formed after_mechanochemical activation in a beater mill.

All samples contained 5 g Polyhalite+5 g urea and pre dried 1.75 g lignite 15% (molar ration polyhalite:urea:1:10).

Whereas sample XXII, marked as H was treated for 2 minutes, sample XXIII, marked as I was treated for 5 minutes and sample XXIV, marked as J was treated for 10 minutes.

The graph also depicts the TG of sample XXII, marked therein as K.

As can be seen in FIG. 23, the exothermic peak which is typical to calcium sulphate-urea cocrystal increase while adding 15% lignite.

### Example 19—Adding Gypsum

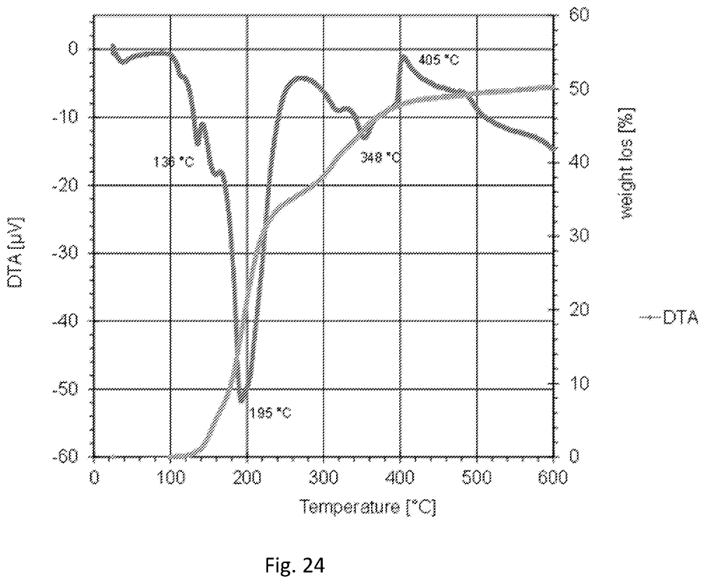

Reference is made to FIG. 24 which depicts DTA/TG graphs of a cocrystal of 1 g polyhalite, 1 g urea (1:10) and 1.75 g gypsum after activation for 5 minutes in a beater mill.

### Example 20

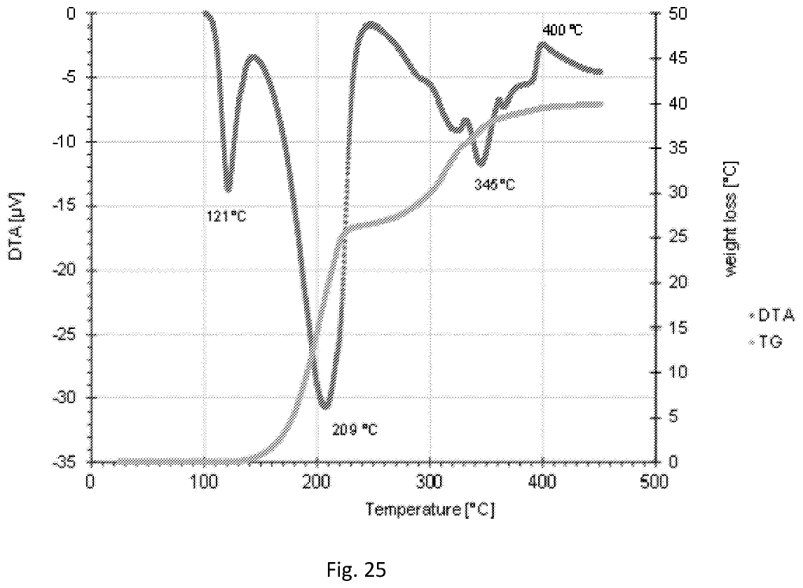

Reference is now made to FIG. 25 which depicts DTA and TG graphs of a cocrystal prepared by mixing of 300 g Polyhalite with 240 g urea for 2 hours in a ball mill, molar ratio polyhalite:urea 1:8.

### Example 21

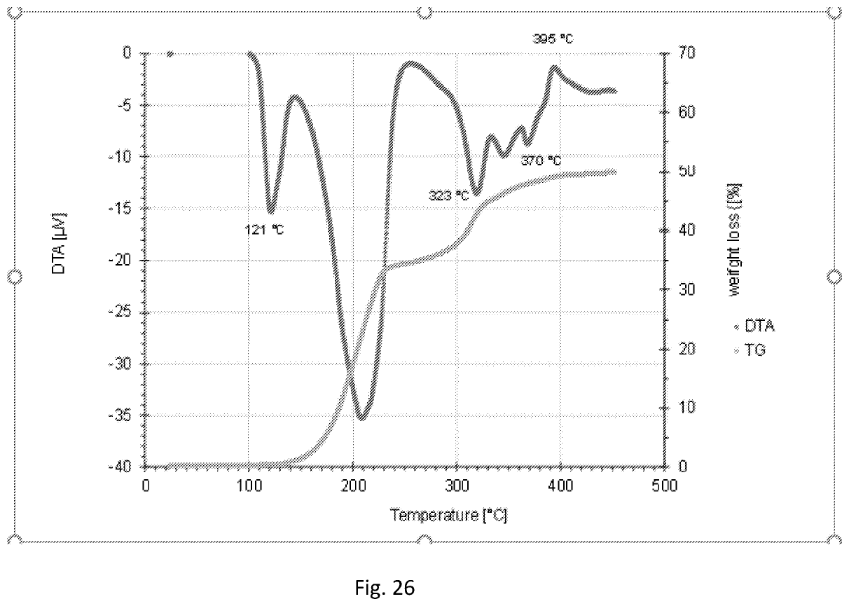

Reference is now made to FIG. 26 which depicts DTA and TG graphs of a cocrystal prepared by mixing of 300 g polyhalite with 250 g urea for 2 hours in a ball mill, molar ratio Polyhalite:urea 1:8.

From FIGS. 25 and 26 it can be seen that there are peaks around 370 degrees and 400 degrees (exothermic) which are typical to a CaSO₄-urea cocrystal. From this it is evident that polyhalite can form a cocrystal with urea.

### Example 22

### Formation of Granular Cocrystal in a Single Step

We used an Eirich mixer at high rpm to produce a cocrystal of Polyhalite-urea.

The first step is to create a reference graph, we therefore formed a cocrystal of gypsum-urea in an Eirich mixer.

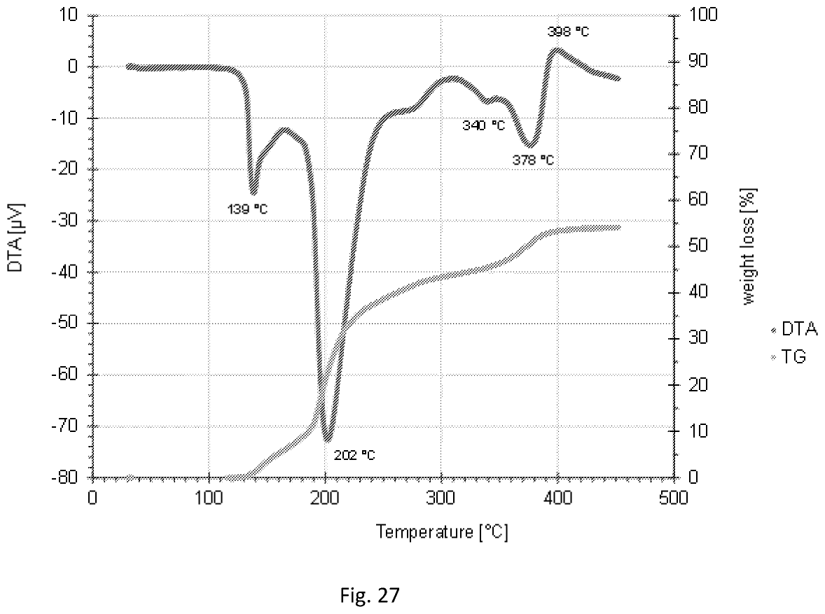

Reference is made to FIG. 27 which depicts the DTA and TG graphs of a CaSO₄-urea adduct in the Eirich mixing device (200 gypsum+278 g urea, 1 h, 3000 RPM).

The second step is to obtain a Polyhalite-urea cocrystal using the same technology.

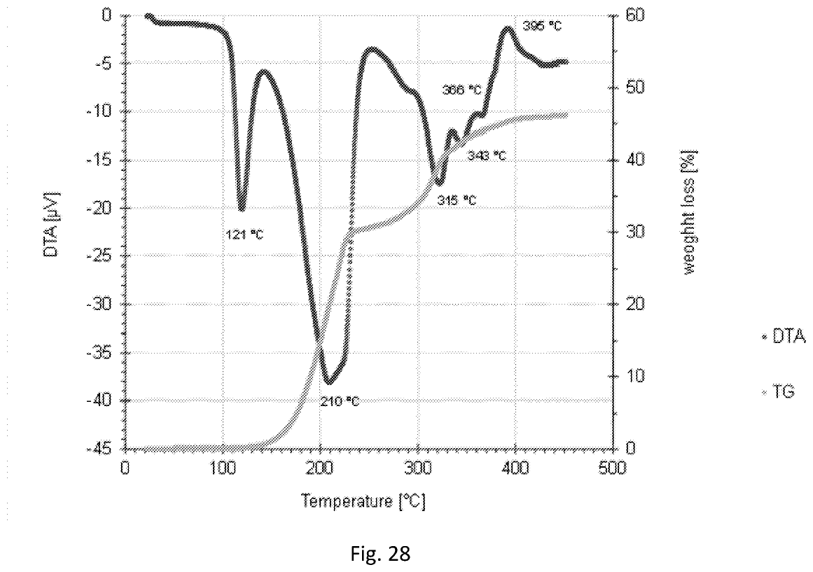

Reference is made to FIG. 28 which depicts the DTA and TG graphs of a cocrystal resulting from mixing 300 g Polyhalite with 200 g urea for 1 hour at 5000 RPM in an Eirich mixer wherein the molar ratio Polyhalite:urea is 1:6.

### Examples 22

We have repeated the experiments with Polyhalite and Ammonium Sulphate, Polyhalite and MAP and Polyhalite and DAP.

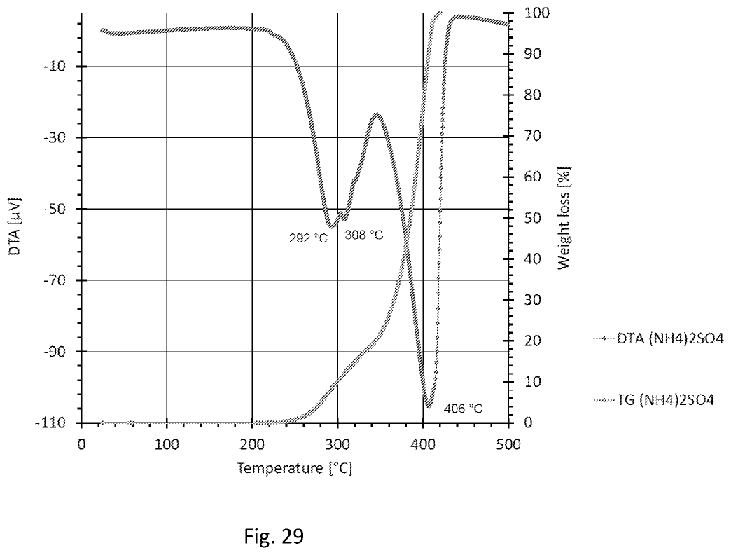

Reference is now made to FIG. 29, which depicts a graph of the DTA and TG of (NH₄)₂SO₄, according to some embodiments.

### Example 23

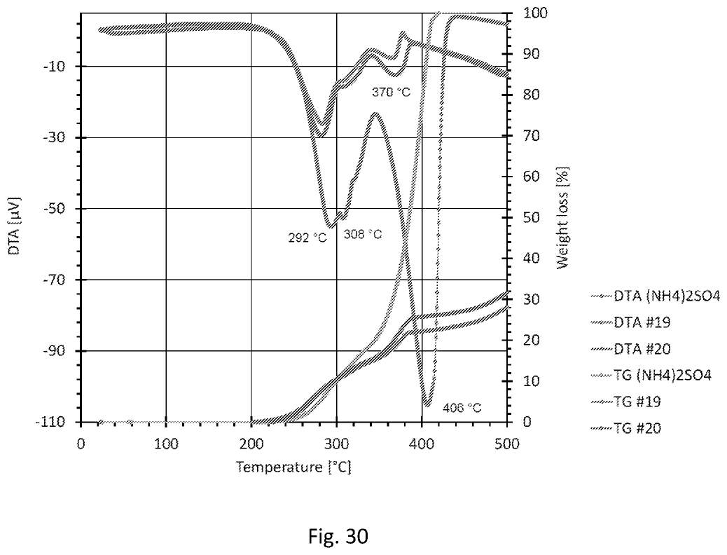

Reference is made to FIG. 30 which is a graph of DTA/TG of (NH₄)₂SO₄ in comparison to Polyhalite/(NH₄)₂SO₄ mixtures treated in an Eirich mixing device.
Sample 19: 300 g Polyhalite+130 g (NH₄)₂SO₄, 1 h, 5000 RPM
Sample 20: 300 g Polyhalite+130 g (NH₄)₂SO₄, 1 h, 7200 RPM

In the above two figures we can see that the formed cocrystal may have a peak at around 370-400 degrees. The cocrystal contains: K, Mg, Ca, SO₄, N

### Example 24

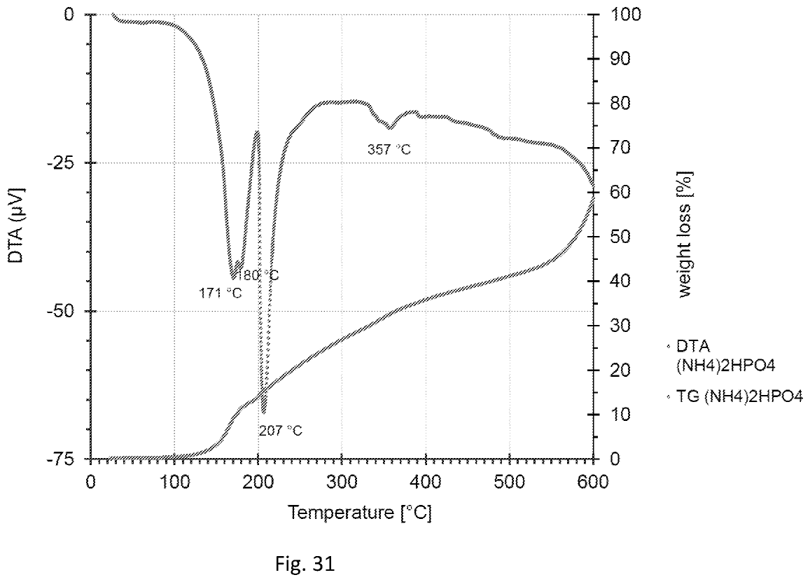

Reference is now made to FIG. 31, which depicts a graph of DTA/TG of (NH₄)₂HPO₄

### Example 25

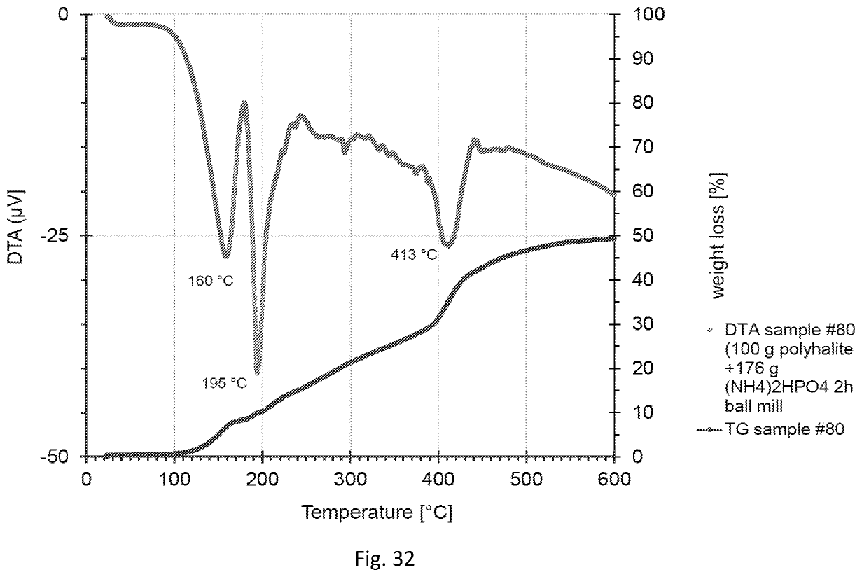

Reference is made to FIG. 32, which the DTA and TG graph of a sample of 100 gr Polyhalite and 176 gr (NH₄)₂HPO₄ having been placed in a ball mill for 2 hours.

From FIGS. 31 and 32 one can deduct that a cocrystal is formed between Polyhalite and DAP, resulting from the mixing of Polyhalite and DAP in a ball mill and/or a high shear mixer, at room temperature.

This cocrystal may have a peak at around 410-420 degrees, and may contain: K, Mg, Ca, SO₄, PO₄.

### Example 26

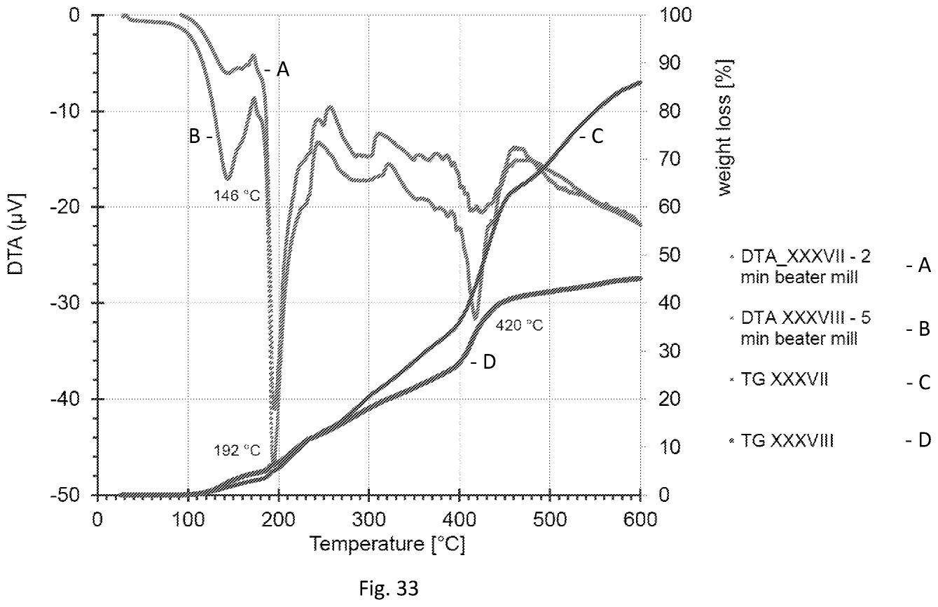

Reference is made to FIG. 33, which depicts the DTA and TG graphs of a cocrystal formed by mixing in beater mill for 2 minutes 2 gr Polyhalite with 3.5 gr of (NH₄)₂HPO₄. As can be seen a peak appears in the same range.

### Example 27

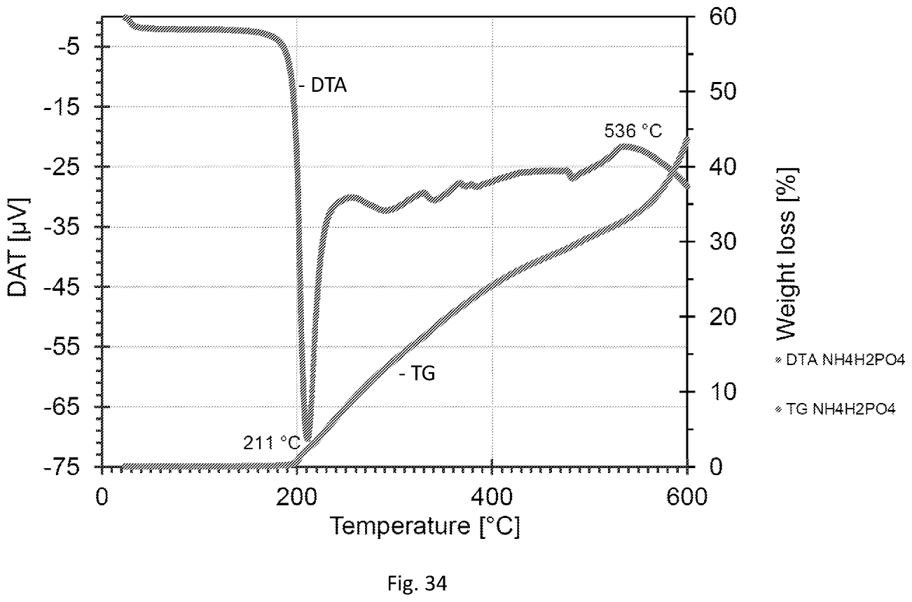

Reference is made to FIG. 34, which depicts a DTA and TG graphs of NH₄H₂PO₄ in accordance with some demonstrative embodiments.

### Example 28

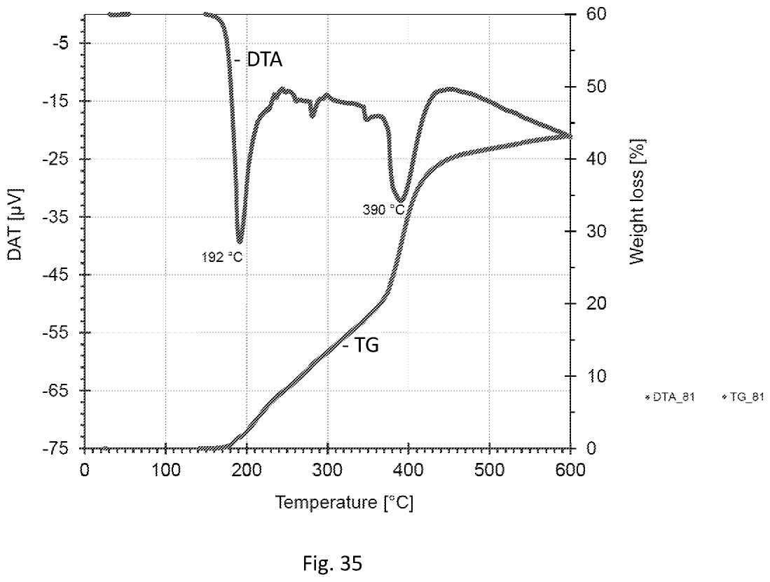

Reference is now made to FIG. 35, which depicts a graph of the DTA and TG of a cocrystal formed by mixing 100 gr Polyhalite and 153 gr NH₄H₂PO₄ for 2 hours in a ball mill.

As can be seen a new peak may appear at around 390 Degrees.

### Example 29

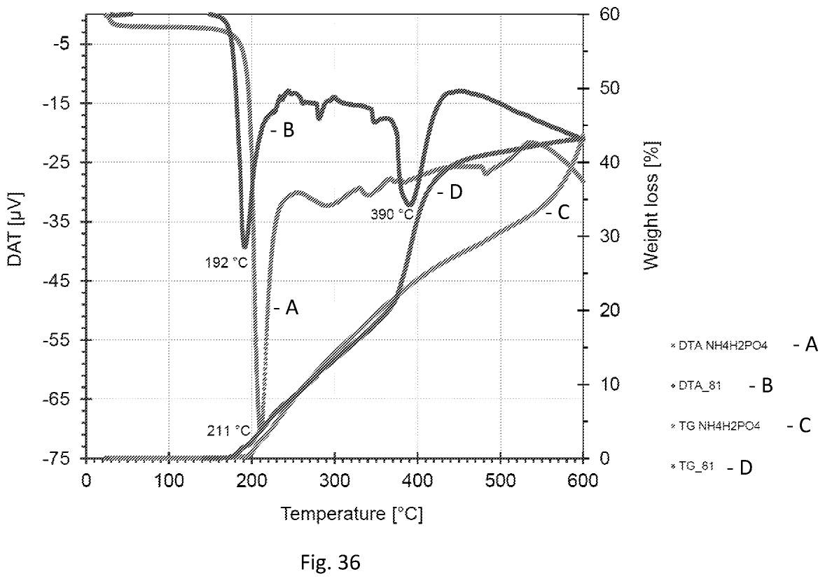

Reference is made to FIG. 36, which depicts a graph showing the DTA and TG of examples 27 and 28 in a single graph.

The same peak appears at 390

### Example 30

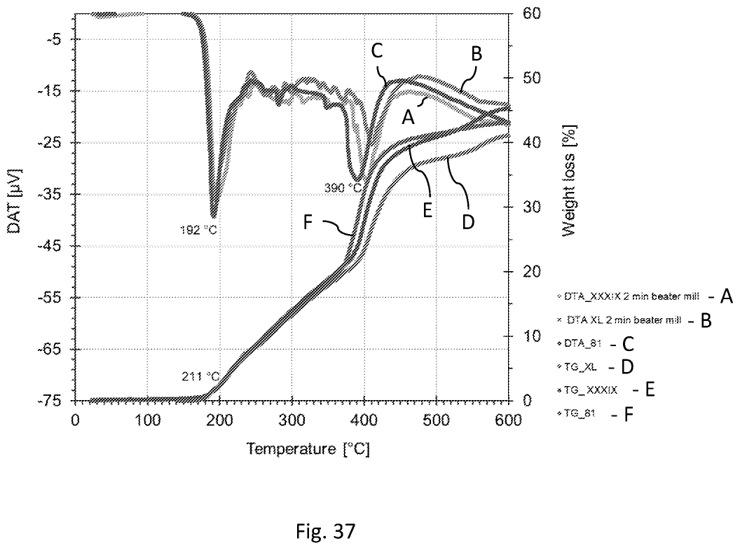

Reference is now made to FIG. 37 which depicts a graph comparing different cocrystals, i.e., mechanochemically treated NH₄H₂PO₄-Polyhalite mixtures.

In FIG. 37, we can see the DTA and TG graphs of:
Sample 81-2 hour ball milling of 100 gr Polyhalite and 153 gr NH₄H₂PO₄ (DTA marked as C, and TG marked as F).
Sample XXXIX—2 gr of Polyhalite and 3 gr of NH₄H₂PO₄, 2 minutes beater milling (DTA marked as A, TG marked as E)
Sample XL—2 gr Polyhalite and 3 gr NH₄H₂PO₄, 5 minutes beater milling (DTA marked as B, TG marked as D).

From the above graphs it is evident that cocrystals may be formed by mixing DAP and/or MAP with Polyhalite, whereas these cocrystals are characterized by having a peak at around 390-420 degrees, and containing: K, Mg, Ca, SO₄, PO₄, N.

As the peaks of polyhalite-MAP, polyhalite DAP appear in the same range, this may imply that the cocrystal formed has a NH₄—Ca connection

### Example 31

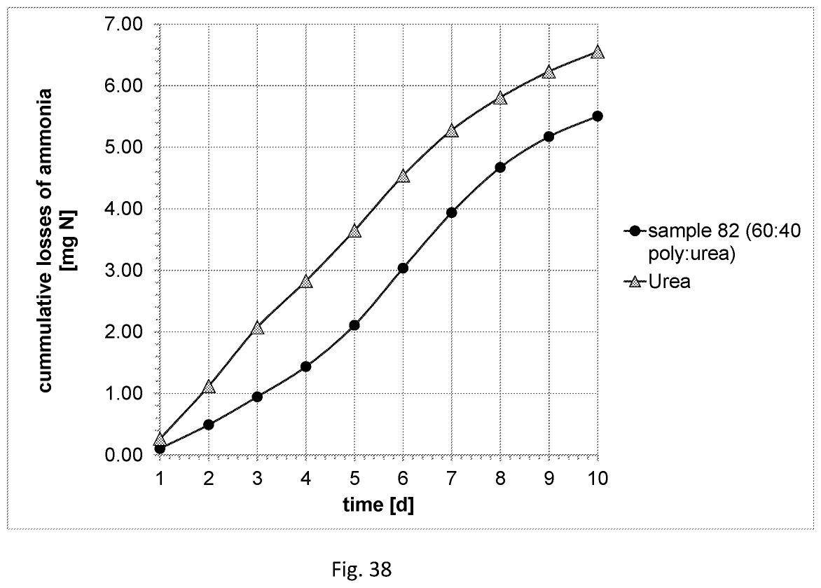

Reference is made to FIG. 38 which depicts a graph demonstrating the volatilization of different formulations, in accordance with some demonstrative embodiments.

The graph of FIG. 38 shows the results of testing percentage of N loss as time passes of different exemplary formulations.

According to some embodiments, the unique combination of Polyhalite and an N-Fertilizer diminishes the volatilization of Ammonia into the atmosphere.

FIG. 38 demonstrates the comparison of 2 formulations and their N volatilization as a function of time:
1. Granular Urea
2. The cocrystal of the present invention in a granular form (sample 82), following ball milling (in a ratio of Polyhalite to Urea 1:1.5)

As can be seen from FIG. 38 the combination of Polyhalite and Urea in the form of a Cocrystal outperforms an urea granule in terms of N volatilization, as the Polyhalite diminishes the vaporization of the Ammonia.

According to some embodiments, various experiments have been conducted, whereas the ratio of Polyhalite to urea of 1.5:1 has provided optimal results with minimal loss of ammonia.

While this invention has been described in terms of some specific examples, many modifications and variations are possible. It is therefore understood that within the scope of the appended claims, the invention may be realized otherwise than as specifically described.

1. A cocrystal of Polyhalite and an N-fertilizer comprising DTA peaks at 115-125 and 202-220 degrees, and another endothermic peak at 345-380 degrees.

2. The cocrystal of claim 1, further comprising another exothermic peak at 390-410 degrees.

3. The cocrystal of claim 1, wherein the ratio between said Polyhalite and said N-fertilizer is between 1:5 to 5:1.

4. The cocrystal of claim 1, wherein the ratio between said Polyhalite and said N-fertilizer is 1.5:1, respectively.

5. The cocrystal of claim 1, comprising less than 10% wt of water at 75% RH after 50 hours from creation.

6. The cocrystal of claim 1, wherein said N-fertilizer is selected from the group including Nitrate salts, Ammonium salts, ammonium nitrate, calcium ammonium nitrate, magnesium ammonium nitrate, ammonium sulphate and ammonium phosphate.

7. The cocrystal of claim 6, wherein said N-fertilizer is Urea

8. The cocrystal of claim 7, further comprising (NH₄)₂HPO₄

9. The cocrystal of claim 7, further comprising (NH₄)₂SO₄.

10. The cocrystal of claim 1, wherein said N-fertilizer is (NH₄)₂SO₄

11. Use of a cocrystal of Polyhalite and an N-fertilizer as a fertilizer for the reduction of ammonia emission, wherein said cocrystal comprising DTA peaks at 115-125 and 202-220 degrees, and another endothermic peak at 345-380 degrees.

12. A process for the production of a cocrystal of Polyhalite and N-fertilizer by mixing stochiometric proportions of said Polyhalite and said N-fertilizer, wherein said cocrystal comprising DTA peaks at 115-125 and 202-220 degrees, and another endothermic peak at 345-380 degrees.

13. The process of claim 11, wherein the ratio between said Polyhalite and said N-fertilizer is 1:1.5, respectively.

14. The process of claim 11, wherein said process takes place in a machine selected from the group including ball mill, beater mill, Eirich mixer or high shear mixer.
